(19) United States
(12) Patent Application Publication
(10) Pub. No.: US 2025/0220464 A1
(43) Pub. Date: Jul. 3, 2025

(54) CELLULAR SYSTEM SUPPORT OF END-TO-END REDUNDANT TRANSPORT AT SERVICE LAYER

(71) Applicant: CONVIDA WIRELESS, LLC, Wilmington, DE (US)

(72) Inventors: Quang LY, North Wales, PA (US); Catalina MLADIN, Hatboro, PA (US); Dale SEED, Allentown, PA (US); Lu LIU, Conshohocken, PA (US)

(21) Appl. No.: 18/850,828

(22) PCT Filed: Mar. 28, 2023
(86) PCT No.: PCT/US2023/016546

§ 371 Date: Sep. 25, 2024

Related U.S. Application Data
(60) Provisional application No. 63/324,550, filed on Mar. 28, 2022.

(51) Int. Cl. H04W 24/04; H04W 24/08; H04W 40/22; H04W 76/15

(52) U.S. Cl. CPC H04W 24/04; H04W 24/08; H04W 40/22; H04W 76/15

(57) ABSTRACT

Disclosed herein are methods and systems for the support of redundant transport in a cellular system at an application layer. A user equipment may establish a first connection and a second connection to a wireless network. The user equipment may transmit data to a receiver device via both the first and second connection. The first and the second connections may be redundant connections. The methods and systems are applied in the context of 3GPP SA6 Service Enabler Architecture Layer for Verticals (SEAL) and Key Issue #1 of 3GPP TR 23.700-34.

### CROSS-REFERENCE TO RELATED APPLICATIONS

This application claims the benefit of U.S. Patent Application No. 63/324,550, filed Mar. 28, 2022.

### BACKGROUND

3GPP SA6 defines the Service Enabler Architecture Layer for Verticals (SEAL) to provide for a horizontal layer in which common services are made available to the vertical application layer, in for example: 3GPP TS 23.434, Service Enabler Architecture Layer for Verticals (SEAL); Functional architecture and information flows; V17.4.0; 3GPP SP-210955, Study on SEAL data delivery enabler for vertical applications; and 3GPP TR 23.700-34, Study on SEAL data delivery enabler for vertical applications; V0.3.0.

### SUMMARY

Methods and systems are described herein for the support of redundant transport in a cellular system at a service layer. For example, redundant transport may be provided by the SEAL Data Delivery (SEALDD) layer of a 5G application enabler system as the SEALDD layer may offer common, horizontal services to some or all vertical applications. This approach may centralize the support of redundant transport at the SEALDD layer to ensure compatibility among various vertical applications and to minimize duplication of functionality at vertical application layers that may not be compatible. Application clients and servers may utilize a common interface to obtain reliable communications without the need to support session management functionalities required by redundant transport.

In one aspect, an API definition is described for application clients and servers to request data delivery service from the SEALDD layer and may provide application client triggered as well as application server triggered procedures for enabling communications with redundant transport. In addition, the SEALDD layer may also initiate an upgrade of single transport communication to redundant transport communication for reliable data delivery.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 shows an example architecture for a service enabler layer.

FIG. 2 shows an example method.

FIG. 3 shows an example method.

FIG. 4 shows an example method.

FIG. 5 shows an example method.

FIG. 6 shows an example method.

FIG. 7 shows an example computing device interface.

FIG. 8A shows an example system.

FIG. 8B shows an example apparatus.

FIG. 8C shows an example system.

FIG. 8D shows an example system.

FIG. 8E shows an example system.

FIG. 8F shows an example system.

FIG. 8G shows an example system.

### DETAILED DESCRIPTION

Methods and apparatuses are described herein for support of redundant transport in a cellular system at a service layer.

The following abbreviations may be used herein:

| | |
|---|---|
| 3GPP | Third Generation Partnership Project |
| 5GS | 5G System |
| AF | Application Function |
| API | Application Programming Interface |
| AS | Application Server |
| DNAI | Data Network Access Identifier |
| FQDN | Fully Qualified Domain Name |
| GUI | Graphical User Interface |
| MNO | Mobile Network Operator |
| NEF | Network Exposure Function |
| NWDAF | Network Data Analytics Function |
| OAM | Operations, Administration, and Management |
| PCF | Policy Control Function |
| Qos | Quality of Service |
| RAN | Radio Access Network |
| RSD | Route Selection Descriptor |
| RSN | Redundancy Sequence Number |
| SEAL | Service Enabler Architecture Layer for Verticals |
| SEALDD | SEAL Data Delivery |
| S-NSSAI | Single Network Slice Selection Assistance Information |
| UE | User Equipment |
| URLLC | Ultra-Reliable Low Latency Communication |
| URSP | UE Route Selection Policy |
| VAL | Vertical Application Layer |

### SEAL Architecture

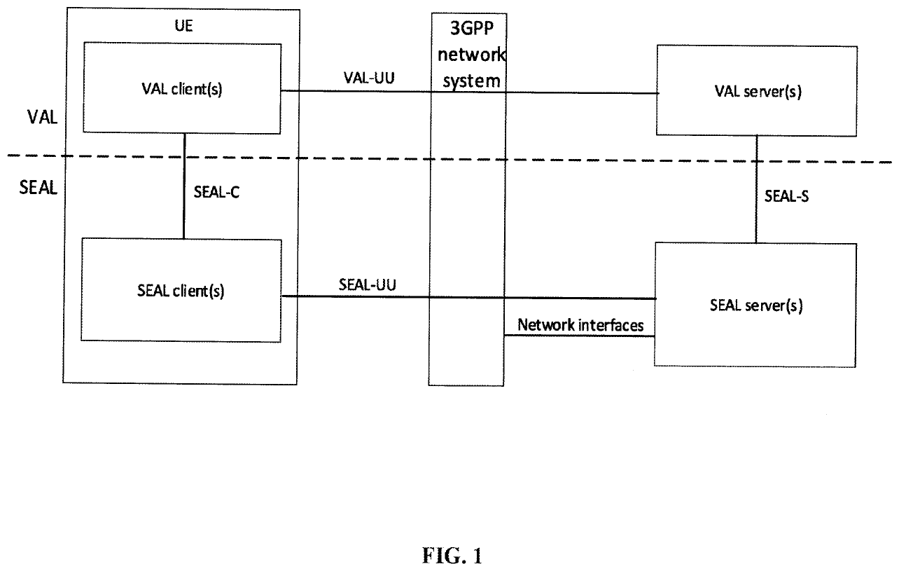

FIG. 1 is copied from 3GPP TS 23.434 and shows an example of the Service Enabler Architecture Layer for Verticals (SEAL) defined in the 3GPP SA6 working group. SEAL may provide a horizontal layer in which common services are made available to the vertical application layer. Examples of the common services comprise: Location management; Group management; Configuration management; Identity management; Key management; and/or Network resource management.

Vertical Application Layer (VAL) client(s) may access one or more services offered by SEAL client(s) on the UE, which may transport traffic to SEAL server(s) using the SEAL-UU interface. The SEAL server may route the traffic to the destination VAL server(s) and may communicate with other SEAL server(s). In addition, the SEAL server(s) may have access to network exposure information via network interfaces with the 3GPP network. The SEAL services may be accessed by VAL clients and VAL servers via API exposure of the common functions offered by the SEAL layer to at least a plurality of vertical applications.

A SEAL server may be deployed as part of a PLMN operator domain or a VAL service provider domain. When deployed in a VAL service provider domain, the SEAL server may have connections to multiple PLMN operator domains. The SEAL server may connect to the 3GPP network system, and one SEAL server may support multiple VAL servers. The functional model of the SEAL layer may be described as on-network in which communications involve the 3GPP network or off-network in which communications occur between two UEs.

### SEAL Data Delivery

In Release 18, 3GPP recognized the need for application layer support of efficient data distribution, delivery, and caching towards the application layer. The study on the SEAL Data Delivery (SEALDD) enabler aims to study new capabilities for data delivery of application data. Aspects of the study comprise potentially integrating existing functionalities such as MSGin5G and data delivery over 5G Mulitcast-Broadcast Services. Other aspects comprise the introduction of new capabilities for supporting application functions such as caching and delivery of application content or data, different application data characteristics, and end-to-end Ultra-Reliable Low Latency Communication (URLLC) data delivery mechanisms. 3GPP SP-210955 captures the objectives of the SEALDD study.

### Redundant PDU Sessions Using Dual Connectivity

Dual connectivity was specified in Release 16 to support URLLC traffic where the UE establishes PDU sessions over a master RAN node and a secondary RAN node. The two PDU sessions are set up with disjointed user plane paths to provide redundancy for the underlying traffic. At the transmitter end, data may be duplicated and sent over both PDU sessions and at the receiver end, data from one PDU session may be eliminated when data is available from both PDU sessions. In the event data from one PDU session is lost, the receiver may be able to use data from the other PDU session to continue service uninterrupted.

In Release 17, redundant transmission using dual connectivity was enhanced to provide the RAN node with both a Redundancy Sequence Number (RSN) and a PDU Session Pair ID. The RSN, which was already provided to the RAN node in Release 16, only informs the RAN node whether a PDU session was redundant. However, the RAN node did not know which PDU session pair was redundant and could be associated with each other until the introduction of the PDU Session Pair ID in Release 17. The RAN node may use the PDU Session Pair ID to associate the PDU sessions and further optimize the redundant traffic. The PDU Session Pair ID and RSN values are defined in UE Route Selection Policy (URSP) rules that the UE uses to route application traffic to PDU sessions the UE establishes with the 5G core network.

### Network Data Analytics Function

The 5G network may expose information about the UE and the performance of the network through the use of analytics provided by the Network Data Analytics Function (NWDAF). Application servers may have direct access to the NWDAF if they are operated by the mobile network operator or via the Network Exposure Function (NEF) if the application server is a third party. The NWDAF may provide statistics or predictions on such information as observed service experience, network function loading, network performance, UE mobility, UE communications, user data congestion, QOS sustainability, etc.

One aspect of the SEALDD study focuses on the support of end-to-end data delivery mechanisms for URLLC cases. This aspect was captured as Key Issue #1 in 3GPP TR 23.700-34. The support for end-to-end data delivery depends on the availability of dual connectivity functionality introduced in Release 16. Currently, dual connectivity support is at the lower layers of the protocol stack and as a result, it is expected that upper layer support is required to take advantage of dual connectivity for redundant transmission. Therefore, the application layer may need to support data replication and elimination required for redundant transmission.

Key Issue #1 of 3GPP TR 23.700-34 notes that upper layer protocols supporting redundant communications may not always be available for application clients and that procedures to use redundant user plane paths are not yet defined. Therefore, support for packet/data duplication and elimination are needed at the application layer to enable end-to-end redundant transport. In addition, the new enabler service needs to properly interact with existing dual connectivity functionality provided by the 5G network. Finally, having the redundant communication support at the SEALDD layer enables multiple vertical applications to take advantage of the redundant transport.

The support of redundant transport may best be provided by the SEALDD layer of the 5G application enabler system as the SEALDD layer offers common, horizontal services to all vertical applications. Example approaches described herein centralize the support of redundant transport at the SEALDD layer, ensuring compatibility among various vertical applications and reducing or avoiding duplication of functionality at vertical application layers that may not be compatible. Application clients and servers may utilize a common interface to obtain reliable communications without the need to support session management functionalities required by redundant transport.

The examples described herein propose an API definition for application clients and servers to request data delivery service from the SEALDD layer and provide application client triggered as well as application server triggered procedures for enabling communications with redundant transport. In addition, the SEALDD layer may also initiate an upgrade of single transport communication to redundant transport communication for reliable data delivery.

An example described herein comprises a method for a SEALDD client to: 1) receive a first request for a data delivery service from an application or VAL client, wherein the first request may comprise information for application traffic. The information for application traffic may comprise at least one of an application identifier, an application server contact information (FQDN, IP address and port number), QoS requirements, an indication for reliable communication, temporal restrictions, spatial restrictions, UE mobility information, utilize edge resources; 2) determine based on information received in the first request that redundant transport is required to meet the data delivery requirement of the application or VAL client; 3) discover a SEALDD server that can serve the application traffic and send a second request to the SEALDD server to configure the application traffic for redundant transport; 4) receive a response to the second request indicating the status of the request for redundant transport; 5) send a response to the application or VAL client with a status to the first request for data delivery service; 6) send a third and a fourth request for the user equipment to establish redundant PDU sessions with the network; or 7) receive data from the application client or application server, and process the data to send to the redundant PDU sessions established in the third and fourth requests wherein processing the data may comprise data segmentation, data duplication, data elimination, and data re-assembly.

An example described herein comprises a method for a SEALDD server to: 1) Detect a trigger condition to send a request to a cellular network to influence traffic for a UE, wherein the trigger condition may be one or more of the following: receive a first request for data delivery service from an application or VAL server to configure a communication session for application traffic, and receive a notification from a cellular network regarding one or more events that may impact the application traffic of a UE (e.g., network congestion, etc.); 2) send a second request to a cellular network to influence traffic for application traffic of a user equipment using information from the first request. The second request may comprise one or more of AF identifier, service parameters describing the application traffic (e.g. such as DNN, S-NSSAI, UE application descriptor, AF service identifier), target UE identifier(s) or information about the UE(s), UE location(s), redundant transport information, temporal and spatial validity conditions, application or VAL server contact information such as FQDN or IP address and port number wherein the redundant transport information may comprise PDU Session Pair ID and Redundancy Sequence Number. The second request may result in the network sending a user equipment one or more UE Route Selection Policies (URSP) for use in establishing PDU sessions for the application traffic wherein the URSP may comprise information in the second request; 3) send a message to notify a SEALDD client for configuring redundant transport for the application traffic; 4) receive an acknowledge to the message that redundant transport has been configured for the application traffic; 5) send a response to the first request that data delivery service has been established; and 6) receive application data on the redundant transports and reassembling the data to send to the application server.

An example described herein comprises a method for a SEALDD client to: 1) receive a first request for a data delivery service from an application or VAL client, wherein the first request may cause a user equipment to create a PDU session to carry application traffic from the UE to an application server: 2) detect data communication for the application traffic is unreliable, where the user equipment needs to retransmit data packets to the application server; 3) send a second request to a SEALDD server to configure the application traffic for redundant transport. The second request may result in the SEALDD server sending to the network a third request, which may comprise an AF identifier, service parameters describing the application traffic (e.g. such as DNN, S-NSSAI, UE application descriptor, AF service identifier), target UE identifier(s) or information about the UE(s), UE location(s), redundant transport information, temporal and spatial validity conditions, application or VAL server contact information such as FQDN or IP address and port number, wherein the redundant transport information may comprise PDU Session Pair ID and Redundancy Sequence Number. The third request may result in the network sending a user equipment one or more UE Route Selection Policies (URSP) for use in establishing PDU sessions for the application traffic wherein the URSP may comprise information in the third request; 4) receive a response to the second request indicating the status of the request for redundant transport; 5) send a response to the application or VAL client on the status of the first request for a data delivery service; 6) send a third and a fourth request for the user equipment to establish PDU sessions with the network; and 7) receive data from the application client or application server, and process the data to send to the PDU sessions established in the third and fourth requests wherein processing the data may comprise, data segmentation, data duplication, data elimination, and data re-assembly.

As the SEALDD layer provides data delivery services to application or VAL clients and servers, an API service request may be defined to enable the application or VAL clients and servers access to the service. Using the API definition, an application or VAL client or server may request for redundant transport and the SEALDD layer may perform the required communications to enable the service. The SEALDD client may communicate with lower layers of the UE and the SEALDD server may communicate with the 5G core network and OAM systems. Note the terms application and VAL are used interchangeably hereinafter to refer to client or server operations that are performed at the vertical application layer on a UE or application server respectively. In addition, the terms redundant transport, redundant PDU sessions, and reliable communication refer to the fact that redundancy has been established for application traffic to flow over disjointed user paths to minimize communication interruptions.

API Exposure for Triggering SEALDD Service with Redundant Transport

Table 1 shows an example API definition an application client or server may use to request for data delivery service from the SEALDD layer. The API definition shown in Table 1 provides a non-exhaustive list of parameters and the associated requirement for inclusion in the API call, specified by the M/O column with M representing mandatory inclusion in the API and O representing Optional inclusion. Request for redundant transport may be explicitly indicated through the Reliable communication parameter.

TABLE 1
SEALDD Service Request Example API Definition

| Parameter | M/O | Description |
|---|---|---|
| Requester identifier | M | The identifier of the requester, which may be a VAL user ID or |
| | | a VAL UE ID |
| UE identifier | M | The identifier of the UE for which the application traffic |
| | | originates from. |
| Application | M | An identifier for the application traffic. |
| identifier | | |
| Server contact | M | The contact information for the application or VAL server, such |
| information | | as the FQDN or IP address and port number. |
| QoS requirements | M | QoS requirements for the application traffic such as data bit |
| | | rate, latency, etc. |
| Reliable | O | An indication that reliable communication is required. This may |
| communication | | be an explicit indication that redundant transport is requested |
| | | for the application traffic. |
| Temporal or spatial | O | Any restrictions on time or location that the application traffic |
| restrictions | | may have. For time restrictions, examples may comprise “for |
| | | the next x hours”, “from 5pm to 10pm”, a periodic time such as |
| | | “M-F, 9am-5pm”, etc. For location restrictions, a list of |
| | | available tracking area, cells, or geographic locations the |
| | | application traffic is limited to. |
| UE mobility | O | A list of tracking area or cells where the UE is at and where the |
| information | | UE is moving to. Alternatively, the information may be |
| | | geographic information (such as GPS locations, address) where |
| | | the UE is currently at and where the UE is moving to. |
| Edge computing | O | An indication specifying whether to use edge computing |
| resources | | resources for the application traffic or a list of DNAIs the |
| | | application traffic is allowed to be exchanged. |

The Service Request API comprises one or more mandatory parameters the requester provides in order to access the SEALDD service. Identifiers are required for the requester, the UF where the application traffic originates, and the application identifier. In addition, the server contact information for which the traffic is destined to and any QoS requirements for the application traffic are also required. This information allows the SEALDD layer to effectively manage the traffic between the UE and the application server.

Other optional information may be provided to allow the SEALDD layer to better manage the application traffic between the UE and the application server. If the application traffic requires low latency or high reliability, the Reliable communication parameter may be explicitly indicated to inform the SEALDD layer to initiate the establishment of redundant transport for the UE. Any known temporal or spatial restrictions may also be provided to ensure the application traffic is allowed during the time and location that the application traffic is authorized for. A UE's mobility information, if known, may be provided to assist the SEALDD layer in managing service continuity issues, especially if edge computing information is also provided.

The SEALDD Service Request API may be accessed by either an application client or server to initiate the services of the SEALDD layer. In an example of a gaming use case, an application or VAL client may access the API upon the launch of a game by the user of a UE. Similarly, an application or VAL server may access the API on behalf of the user of the UE after the user registers to the application or VAL server to establish a gaming session.

The API may be accessed for cases where application traffic has been established initially without the assistance of the SEALDD layer and later upgraded to using SEALDD service with redundant transport due to low quality of service. For the cases, the application traffic was initially established using a single transport without using SEALDD services. The application traffic may experience QoS degradation and either an application client or server may access the Service Request API to request the assistance of the SEALDD layer to improve the QoS of the application traffic, for example by upgrading to use redundant transport.

While the reliable communication parameter may be provided for explicit indication of redundant transport, the SEALDD layer may also infer the need for redundant transport using the QoS requirement provided by the application client or server and other information the SEALDD layer has about the UE or provided by the network that indicates performance degradation in the system. The SEALDD client may have access to information on UF capabilities, UF mobility, performance measurements from lower layers, and other application or edge computing information that may be utilized to determine the need for redundant transport. A SEALDD server may use information about a UE (e.g. obtained from a SEALDD client, an application server, the 5G network, or OAM systems) and also information on network performance and analytics (e.g. obtained from the 5G network or OAM systems) to make the determination for redundant transport.

A response may be returned to the requester on the status of the service request, which may also comprise a transaction identifier. In the case the requested service was not able to be granted, the response may also comprise an error code and potentially with additional information on why the request was not granted.

The Service Request API definition shown in Table 1 may be a generic API that applies to both application clients and application servers for obtaining SEALDD services. As such, some parameters may only be exposed to application servers and not to application clients. For example, the Edge computing resources parameter may only be exposed to application servers to request SEALDD services for traffic from an application on a UE. The application server may have additional information about the UE such as the location, the relative distance of the UE to the application server, and UE mobility predictions from the NWDAF to make the determination for requesting reliable communication for the UE as well as using edge computing resources when necessary.

### SEALDD Layer Support for Redundant Transport

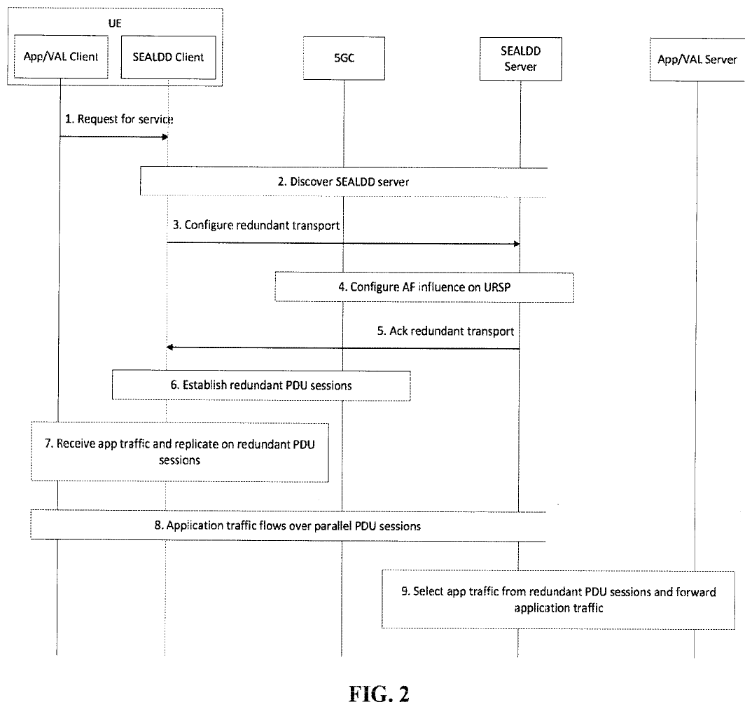

The SEALDD service request API may allow application clients or servers to request for reliable communications from the SEALDD layer. Upon receiving the service request API, the SEALDD layer performs the communications to enable the data delivery service with redundant transport. FIG. 2 shows an example of an application client on a UE making a service request to use the SEAL data delivery service with redundant transport. In this example, the application client may have been provisioned or configured with the contact information of an application server to send the application data to. The contact information may be an FQDN or IP address and port number of the application server.

In step 1, an application or VAL client on a UE makes a request for data delivery service from the SEALDD layer to send application traffic to an application or VAL server. The request may comprise one or more of an application identifier, the application or VAL server contact information such as an FQDN or IP address and port number, the QoS requirement for the traffic, possibly UE mobility information, an indication for reliable communication if desired, and any known temporal or spatial restrictions for the application traffic. The UE mobility information may be an indication of UE mobility or it may be more detailed location information obtained from a navigation application on the UE showing a planned route.

In step 2, the SEALDD client on the UE may process the request and make a determination based on the information provided by the application or VAL client to use redundant transport for the application traffic. The SEALDD client may make the determination based on one or more of the specified QoS requirement, the presence of an indication for reliable communication, and/or performance measurements obtained from lower layers of the UE, e.g. signal strength is low. The SEALDD client may perform a SEALDD server discovery to find a SEALDD server that supports redundant transport and can serve the UE.

In step 3, the SEALDD client may send a request to the SEALDD server to configure redundant transport for the application on the UE and may comprise one or more of an application descriptor (e.g. operating system identifier and version, application identifier) for the traffic, the UE's identifier and location, UE capabilities, QoS requirements, an indication for reliable communication, the temporal and/or spatial restrictions for the application traffic, UE mobility information, UE performance measurements such as signal strength obtained from lower layers, the application or VAL server contact information such as an FQDN or IP address and port number, data segmentation requirement and packet size, etc. The SEALDD client may factor performance measurements obtained from lower layers in making the determination for redundant transport or for the use of data segmentation. Alternatively, the SEALDD client may forward the information about the UE without making the determination for redundant transport and let the SEALDD server make the determination to use redundant transport based on the provided information.

In step 4, the SEALDD server, acting as an Application Function (AF), may initiate the AF influence on URSP procedure with the 5G core network. The SEALDD server may cause, in the request, one or more of a service description that may be an AF identifier, service parameters describing the application traffic (e.g. such as DNN, S-NSSAI, CE application descriptor, AF service identifier), target UE identifier(s) or information about the UF(s), UF location(s), UF capabilities, redundant transport information, temporal and spatial validity conditions, application or VAL server contact information such as an FQDN or IP address and port number, subscription information for receiving notifications, etc. The UE may receive updated URSP rules in which the Traffic Descriptors and/or the Route Selection Descriptors (RSD) comprise information provided by the SEALDD server. Some examples comprise the IP descriptors comprising the application or VAL server IP address and port number, the Domain descriptor comprising the FQDN, and/or the RSD comprising the redundant transport information such as PDU Session Pair ID and RSN values to enable redundant PDU sessions for the UE. The PDU Session Pair ID and RSN values may have been provided to the SEALDD server by the 5G core network, the OAM system, or as part of pre-configuration. Alternatively, the SEALDD server may have been provisioned with mapping information correlating DNN and/or S-NSSAI with PDU Session Pair ID and RSN values.

In step 5, the SEALDD server may respond to the SEALDD client that redundant transport is enabled for the application traffic. The response may comprise information on one or more of the temporal and spatial limitations of the redundant transport and the selected data segmentation packet size. The SEALDD client may respond to the application or VAL client with the status of the service request.

In step 6, the SEALDD client may trigger the UE to establish redundant PDU sessions using the updated URSP rules and with dual connectivity. As a result, the PDU sessions are established with disjointed user plane paths.

In step 7, the SEALDD client may receive application data and replicate the data on the redundant PDU sessions. The SEALDD client may apply segmentation of the data before replication if data segmentation was enabled to offer finer granularity of transmission packets for cases in which transmission quality may be low or the size of the application data payload exceeds the max packet size supported by the one or both of the redundant PDU sessions. This may be required if the UE is at the fringe of network coverage to minimize the packet retransmission size for cases when packets from both PDU sessions may be lost. Alternatively, rather than Step 1 and Step 6 requiring separate requests, these steps may be combined into a single request (i.e., application data and/or an indication to establish a session between the application/VAL client and an application/VAL may be included in the request defined in Step 1).

In step 8, the application data may be sent on the redundant PDU sessions over the disjointed user plane paths to the SEALDD server. When sending the application data, the SEALDD client may encapsulate the application data within a SEALDD message. The SEALDD client may also fragment the application data into multiple SEALDD messages. For example, if the application data payload is larger than the maximum packet size configured for the data segmentation requirement. The SEALDD message may also comprise SEALDD headers, which may comprise information such as a SEALDD message identifier or sequence number. The SEALDD header may comprise an indicator of whether a SEALDD message acknowledgement is required to be returned from the SEALDD server to the SEALDD client. Similarly, the SEALDD server may apply data segmentation, if enabled, before performing data duplication to send downlink application traffic to the UE over the disjointed user plane paths.

In step 9, upon receiving the data, the SEALDD server may re-assemble the application data from the received SEALDD messages received from the SEALDD client before sending the re-assembled data to the application or VAL server. As part of re-assembly, the SEALDD server may eliminate duplicate packets from the redundant transport and may also re-assemble application data payload segments fragmented across multiple SEALDD messages. The SEALDD server may also compensate for any lack of message synchronization across the redundant transports. For example, the SEALDD server may compensate for any delays between redundant SEALDD messages it receives by buffering messages from one or both of the PDU sessions. SEALDD message identifiers or sequence numbers in the headers of the SEALDD messages may be used to perform message duplication, fragmentation and reassembly, and synchronization operations. For cases in which data from the same segment(s) are not received on either transport, the SEALDD server may notify the SEALDD client to resend data for those segment(s). This notification may be realized as an acknowledgement that the SEALDD server returns to the SEALLDD client in-band over one or both of the redundant PDU sessions. Alternatively, the notification may be realized as a message sent from the SEALDD server to the SEAL client out-of-band over a separate PDU session. For example, the SEALDD client may have a subscription to receive notifications from the SEALDD server. These notifications may be targeted to a notification URI of the SEALDD client and may use a separate PDU session from the redundant PDU sessions. Since segmentation reduces the size of the data packets, retransmission may be quicker especially if the UF signal strength is weak. Similar to the processing performed by the SEALDD server, the SEALDD client may also perform the same processing (e.g. data de-segmentation, elimination, and re-assembly) for traffic received from the SEALDD server over the disjointed user plane paths.

Note that steps 7 to 9 of FIG. 2 describe the redundant transport of application traffic flow from the UE to the application server on the uplink path. Redundant transport for application traffic flow from the application server to the UE on the downlink path is also supported. For the downlink traffic, the SEALDD server may perform the data segmentation and duplication while the SEALDD client performs the data elimination and re-assembly.

Currently, dual connectivity is only supported for 3GPP access technology. However, redundant transport may also be applied for cases where the redundancy is supported by using one 3GPP access and one non-3GPP access such as Wi-Fi. The same procedure as shown in FIG. 2 may be reused but with a slight change to the Route Selection Descriptor (RSD) of the URSP rule. In this case, the Access Type preference parameter of the RSD may be specified such that one PDU session uses 3GPP access and the other PDU session uses non-3GPP access. The SEALDD client and server may communicate the use of the multiple access types within the SEALDD layer and manage the redundant PDU sessions accordingly. For example, the SEALDD client may duplicate application traffic to both the 3GPP and non-3GPP accesses and the SEALDD server may eliminate data from one of the accesses before sending the application data to the application server. Unlike the dual connectivity approach where the 5G network is aware of and may optimize the redundant PDU sessions, this approach may limit the knowledge of redundant transport to only the SEALDD layer. For certain UEs, dual connectivity may not be available and this approach may allow those UEs to be able to use redundant transport for reliable communications using multiple access types. The SEALDD client on the UE or the SEALDD server in the network may have access to information about the UE's capabilities and make the determination of which approach to use for redundant transport.

Systems and methods are proposed herein for redundant transport. For example, the method described in FIG. 2 may comprise sending, by a redundant transport client and to a redundant transport server, a request for the redundant transport server to configure redundant transport for an application associated with a user device. The method may further comprise receiving, from the redundant transport server, an indication of a redundant transport session associated with the application. The method may further comprise establishing, by the redundant transport client and for the user device, a plurality of redundant protocol data unit (PDU) sessions associated with the user device. The method may further comprise duplicating application data, received from the application associated with the user device, on at least two of the plurality of redundant PDU sessions. The method may further comprise sending, via the at least two of the plurality of redundant PDU sessions, the duplicated application data to the redundant transport server.

The method described in FIG. 2 may further comprise receiving, from the application associated with the user device, a request to send, via redundant transport, the application data to an application server associated with the application.

The method described in FIG. 2 may further comprise wherein the redundant transport server is a suitable redundant transport server of a plurality of redundant transport servers, and the redundant transport client is configured to discover the suitable redundant transport server in response to receiving the request to send the application data via redundant transport.

The method described in FIG. 2 may further comprise wherein the request comprises at least one of an application identifier, an indication of the application server, a quality of service indication associated with the application data, mobility information associated with the user device, a request for reliable communication, or a restriction associated with the application data.

The method described in FIG. 2 may further comprise receiving, in response to the sending the request for the redundant transport, updated user equipment (UE) route selection policy (URSP) rules associated with the redundant transport.

The method described in FIG. 2 may further comprise wherein the redundant transport client is further configured to segment the application data based on at least one of a transmission quality, a size associated with the application data, or a maximum packet size of application data associated with at least one of the redundant PDU sessions.

The method described in FIG. 2 may further comprise wherein the redundant PDU sessions comprise disjointed user plane paths.

The method described in FIG. 2 may further comprise wherein the redundant transport server is configured to send one of the duplicated application data instances to an application server associated with the application.

The method described in FIG. 2 may further comprise wherein the redundant transport server is configured to, based on receiving a plurality of instances of the application data from the redundant PDU sessions, de-duplicate the plurality of instances of the application data.

For example, FIG. 2 may describe a device comprising one or more processors and memory storing instructions that, when executed by the one or more process, cause the server device to perform one or more actions. For example, the device described in FIG. 2 may receive, from a redundant transport client, a request to configure redundant transport associated with an application. The device may further send, to a 5G core network, an application function (AF) influence on a user equipment (UE) route selection policy (URSP) request. The device may send, to the redundant transport client, an indication of implementation of a redundant transport session. The device may receive, from the redundant transport client, at least one copy of application data associated with the application, the at least one copy of application data received via one protocol data unit (PDU) session of a plurality of redundant PDU sessions. The device may send, to an application server associated with the application, the at least one copy of the application data.

The device in FIG. 2 may further comprise wherein the redundant transport client and the application are associated with a user device.

The device in FIG. 2 may further comprise wherein the AF influence comprises one or more of a UE application descriptor, an AF service identifier, an indication associated with the UE, an indication of the application server, or a redundant transport indicator.

The device in FIG. 2 may further comprise wherein the at least one copy of application data is segmented application data, and wherein the server device is configured to send, to the application server associated with the application, the segmented application data.

The device in FIG. 2 may further comprise wherein the plurality of redundant PDU sessions comprise disjointed user plane paths.

The device in FIG. 2 may further receive a plurality of copies of the application data, wherein each copy of the application data is received from one of the plurality of redundant PDU sessions, and the device may further de-duplicate the plurality of copies of the application data.

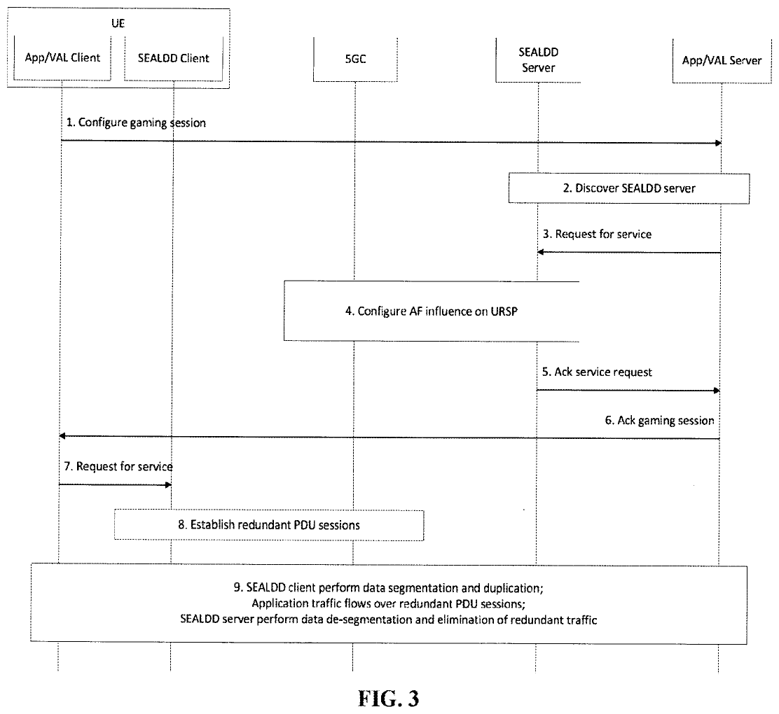

In addition to a SEALDD client initiating the request for redundant transport, a SEALDD server may also initiate the request for redundant transport on behalf of an application or UE. For example, an application on the UE may provide configuration of a gaming session to the application or VAL server, which may trigger the process in which the SEALDD server determines the gaming session would benefit from redundant transport. The application may provide this information during registration or after logging in to the application or VAL server. FIG. 3 shows the procedure where a SEALDD server initiates redundant transport for an application on a UE in support of the gaming session.

In step 1, an application or VAL client may register or log in to an application or VAL server to configure a gaming session for the user of a UE. As part of the configuration, the application or VAL client may provide information about the gaming session to the corresponding application or VAL server, such as application descriptors (e.g. operating system identifier and version, application identifier), QoS requirements, an indication for reliable communication if desired, any known temporal or spatial restrictions for the application traffic, and an indication for using edge computing resources. The QoS requirements may be based on the desired resolution, frame rate, amount of background details, scrolling effects, etc. configured for the application by the user. In addition, other information may also be provided: UE identifier and/or IP address, UE capability (e.g. support for dual connectivity or multiple access technologies), UE location, etc.

In step 2, the application or VAL server may process the request and make a determination based on the information provided by the application or VAL client that SEALDD services are needed for this application traffic. The application or VAL server may make the determination based on one or more of the specified QoS requirement, the presence of an indication for reliable communication, and/or performance measurements obtained from the application or VAL client or from the network. The application or VAL server may perform a SEALDD server discovery to find a SEALDD server that supports the desired SEALDD service (e.g. redundant transport) and can serve the UE.

In step 3, the application or VAL server may make a request to the SEALDD server for data delivery service to be provided for the application traffic. The application or VAL server may include in the request one or more of the UE identifier and/or IP address and port number, the application identifier, QoS requirements, UF location, UF capabilities, an indication for reliable communication, any temporal or spatial restrictions for the application traffic, and an indication for using edge computing resources. The application or VAL server may include an explicit indicator requesting redundant transport. Alternatively, the application or VAL server may not be aware of redundant transport functionality and instead only provide application level information used by the SEALDD server to manage redundant transport.

In step 4, the SEALDD server may utilize the information provided by the application or VAL server to determine whether the session requires low latency or ultra-reliability. In addition, the SEALDD server may use the indication for using edge computing resources with the UE's location to discover a list of DNAIs that could be used to support the application traffic. The SEALDD server, acting as an Application Function (AF), initiates the AF influence on URSP procedure with the 5G core network. The SEALDD server may include in the request an AF identifier, service parameters describing the application traffic (e.g. such as DNN, S-NSSAI, UE application descriptor, AF service identifier), target UE identifier(s) or information about the UE(s), UE location(s), UE capabilities, redundant transport information, temporal and spatial validity conditions, application or VAL server contact information such as FQDN or IP address and port number, subscription information for receiving notifications, etc. The UE may receive updated URSP rules in which the Traffic Descriptors and/or the Route Selection Descriptors (RSD) comprise information provided by the SEALDD server. Examples comprise the IP descriptors comprising the application or VAL server IP address and port number, the Domain descriptor comprising the FQDN, and/or the RSD comprising the redundant transport information such as PDU Session Pair ID and RSN values. The PDU Session Pair ID and RSN values may have been provided to the SEALDD server by the 5G core network, the OAM system, or as part of pre-configuration. Alternatively, the SEALDD server may have been provisioned with mapping information correlating DNN and/or S-NSSAI with PDU Session Pair ID and RSN values.

Using the provided UE identifier and/or IP address and port number, the SEALDD server may configure the SEALDD client that redundant transport has been enabled for the application on the UE. The message may comprise the application identifier, the application or VAL server FQDN or IP address and port number, any temporal or spatial restrictions for the application traffic. The message may also comprise information about one or more URSPs that have been updated or newly configured onto the UE such that the SEALDD client is aware of them. The SEALDD client acknowledges the configuration from the SEALDD server and may comprise an update of the UE location and an indication of data segmentation requirement and packet size for the redundant transport.

In step 5, the SEALDD server may provide a status of the service request to the application or VAL server and may comprise a transaction and/or session identifier and a time stamp for the transaction.

In step 6, the application or VAL server may acknowledge the configuration request to the application or VAL client. The acknowledgement may indicate that SEALDD service have been configured for the application and comprise a list of parameters for the application or VAL client to use when requesting service from the SEALDD client. The list of parameters may comprise information exchanged between the application or VAL server and the SEALDD server.

In step 7, the application or VAL client may make a service request for SEALDD service, possibly using the information provided by the application or VAL server.

In step 8, using the updated URSP rules, the UE may establish redundant PDU sessions using dual connectivity or with multiple access types depending on the capabilities of the UE and base on other information the SEALDD client may have. As a result, the PDU sessions may be established with disjointed user plane paths.

In step 9, the SEALDD client may perform the appropriate data processing (e.g. data segmentation and duplication) of the data received from the application or VAL client and send the duplicated data over the redundant PDU sessions. The SEALDD server may receive the data from the redundant PDU sessions and perform the appropriate data re-assembly to send the data to the application or VAL server. This step corresponds to steps 7 to 9 of FIG. 2. Note that redundant transport is also supported for downlink application traffic. For the downlink traffic, the SEALDD server performs the data duplication and the SEALDD client performs the data elimination and re-assembly.

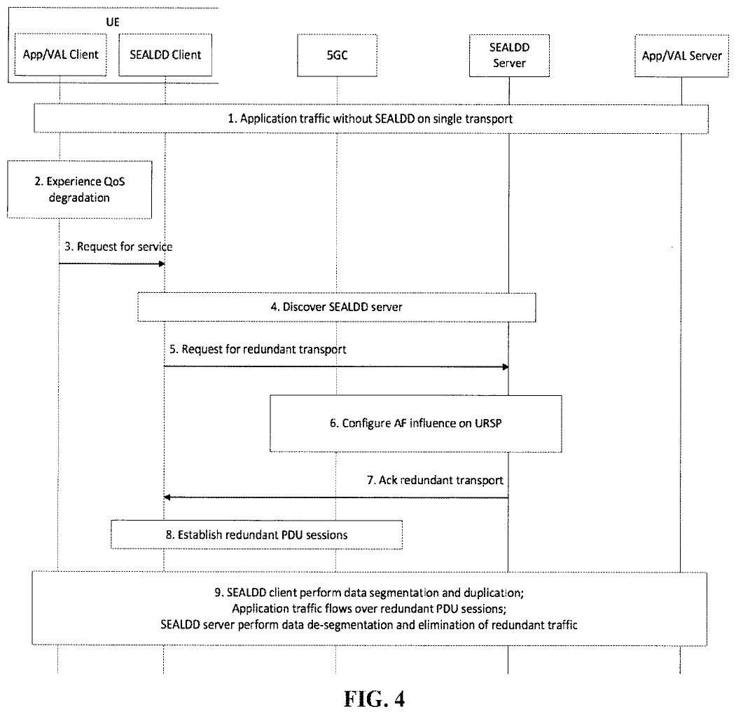

In the previous examples, the SEALDD service for reliable communication was initiated prior to the commencement of application traffic. FIG. 4 shows another example where the SEALDD client could be used to upgrade or transfer application traffic to use redundant transport. The original application traffic may have been established using a single transport and without the services of the SEALDD layer. For this case, the application or VAL client may make a determination to upgrade the application traffic to using reliable communications after experiencing service degradation such as increased buffer times, receiving out of buffer errors, or are missing data.

In step 1, a UE may be sending application traffic that has been established using a single transport and without utilizing the services of SEALDD.

In step 2, the application or VAL client may detect a QoS degradation for the application traffic and decide to request an upgrade of the application traffic to use redundant transport or to transfer the application to use redundant transport

In step 3, the application or VAL client may make a request to the SEALDD client for data delivery service to upgrade the application traffic to using redundant transport. The request may comprise one or more of an application identifier or PDU session ID for the application, the application or VAL server contact information such as an FQDN or IP address and port number, the QoS requirement for the traffic, possibly UE mobility information, an indication for reliable communication if desired, any known temporal or spatial restrictions for the application traffic, and an indication for using edge computing resource. The UE mobility information may be an indication of UE mobility or more detailed location information obtained from a navigation application on the UE showing a planned route.

In step 4, the SEALDD client on the UE may process the request and make a determination based on the information provided by the application or VAL client to use redundant transport for the application traffic. The SEALDD client may make the determination based on one or more of the specified QoS requirement, the presence of an indication for reliable communication, and/or performance measurements obtained from lower layers of the UE, e.g. signal strength is low. The SEALDD client may perform a SEALDD server discovery to find a SEALDD server that supports redundant transport and can serve the UE.

In step 5, the SEALDD client may send a request to the SEALDD server to configure redundant transport for the application on the UE and may comprise one or more of an application descriptor (e.g. operating system identifier and version, application identifier) for the traffic, the UE's identifier and location, UE capabilities, QoS requirements, an indication for reliable communication, the temporal and/or spatial restrictions for the application traffic, UE mobility information, UE performance measurements such as signal strength obtained from lower layers, the application or VAI, server contact information such as an FQDN or IP address and port number, data segmentation requirement and packet size, etc. The SEALDD client may factor performance measurements obtained from lower layers in making the determination for redundant transport or for the use of data segmentation. Alternatively, the SEALDD client may forward the information about the UE without making the determination for redundant transport and let the SEALDD server make the determination to use redundant transport based on the provided information.

In step 6, the SEALDD server may utilize the information provided by the application or VAL server to determine whether the session requires low latency or ultra-reliability. In addition, the SEALDD server may use the indication for using edge computing resources with the UE's location to discover a list of DNAIs that could be used to support the application traffic. The SEALDD server, acting as an Application Function (AF), may initiate the AF influence on URSP procedure with the 5G core network. The SEALDD server may include in the request one or more of an AF identifier, service parameters describing the application traffic (e.g. such as DNN, S-NSSAI, UE application descriptor, AF service identifier), target UE identifier(s) or information about the UE(s), UE location(s), UE capabilities, redundant transport information, temporal and spatial validity conditions, application or VAL server contact information such as FQDN or IP address and port number, subscription information for receiving notifications, etc. The UE may receive updated URSP rules in which the Traffic Descriptors and/or the Route Selection Descriptors (RSD) comprise information provided by the SEALDD server. Examples comprise one or more of the IP descriptors comprising the application or VAL server IP address and port number, the Domain descriptor comprising the FQDN, and/or the RSD comprise the redundant transport information such as PDU Session Pair ID and RSN values to enable redundant PDU sessions for the UE. The PDU Session Pair ID and RSN values may have been provided to the SEALDD server by the 5G core network, the OAM system, or as part of pre-configuration. Alternatively, the SEALDD server may have been provisioned with mapping information correlating DNN and/or S-NSSAI with PDU Session Pair ID and RSN values.

In step 7, the SEALDD server may respond to the SEALDD client that redundant transport is enabled for the application traffic. The response may comprise information on the temporal and spatial limitations of the redundant transport and the selected data segmentation packet size. The SEALDD client may respond to the application or VAL client with the status of the service request.

In step 8, the SEALDD client may trigger the UE to establish redundant PDU sessions with the 5G core network. In this case, the SEALDD client may need to modify the existing PDU session established in step 2 to make it redundant, e.g. by providing the PDU Session Pair ID and the RSN, or the SEALDD client may need to manually manage the two PDU sessions without specifying the PDU sessions are redundant.

In step 9, the SEALDD client may perform the appropriate data processing (e.g. data segmentation and duplication) of the data received from the application or VAL client and send the duplicated data over the redundant PDU sessions. The SEALDD server may receive the data from the redundant PDU sessions and perform the appropriate data re-assembly to send the data to the application or VAL server. Step 9 corresponds to step 9 as described above with respect to FIG. 3.

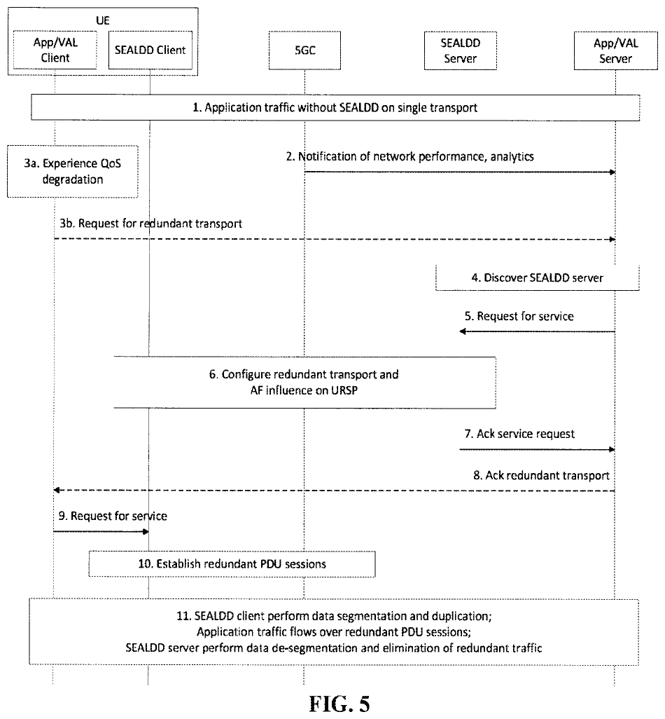

In the previous example, an application or VAL client initiated an upgrade or transfer of application traffic to using SEALDD service with reliable transport. FIG. 5 shows another example where the SEALDD server could be used to upgrade or transfer application traffic to use redundant transport. In a similar fashion, the original application traffic may have been established using a single transport and without the services of the SEALDD layer. For this case, the application or VAL server may make a determination to upgrade or transfer the application traffic to using reliable communications based on receiving notifications from the 5G network that predicts network resource usage is increasing in a particular service area that the UE is moving towards. Alternatively, and also shown in FIG. 5, an application or VAL client may also trigger a request for SEALDD service to the SEALDD server to upgrade the application traffic to redundant transport.

In step 1, a UE is sending application traffic that have been established using a single transport and without utilizing the services of SEALDD.

In step 2, an application or VAL server may be subscribed to receive network performance measurements as well as network generated statistics and predictions from the 5G core network or OAM system. The application or VAL server receives a notification from the 5G core network showing network performance predictions that network resource usage is increasing for a particular service area. In addition, the application or VAL, server may also receive network analytics for UF mobility showing the UF is moving towards the service area where network resource usage is increasing.

In step 3, the application or VAL client may detect a QoS degradation for the application traffic in step 3a and request an upgrade of the application traffic to use redundant transport or to transfer the application traffic to use redundant transport. The request shown in step 3b may comprise information about the UE and application traffic as previously described in step 1 of FIG. 3. Note that in this figure, either step 2 or step 3 or even both step 2 and step 3 may trigger the action performed by the application or VAL server in step 4.

In step 4, the application or VAL server may process the request and make a determination based on the information provided by the application or VAL client that SEALDD services are desired for this application traffic. If the application or VAL server had received notifications from the 5G network or from OAM system in step 2, the application or VAL server may already have information about the UE and the corresponding application traffic. The application or VAL server may also make the determination based on the specified QoS requirement, the presence of an indication for reliable communication, and/or performance measurements obtained from the application or VAL client or from the network. The application or VAL server may perform a SEALDD server discovery to find a SEALDD server that supports the desired SEALDD service (e.g. redundant transport) and can serve the UE as well.

In step 5, in response to the network performance and UE mobility predictions or the application or VAL client request, the application or VAL server may make a request for data delivery service to upgrade or transfer the UE from using a single transport to using redundant transport. The application or VAL server may make a request to the SEALDD server that can serve the UE to configure the UE for redundant transport. The request may comprise one or more of the UE identifier and/or IP address, the application identifier, QoS requirements, UE location, UE capabilities, an indication for reliable communication, any temporal or spatial restrictions for the application traffic, and an indication for using edge computing resources.

In step 6, the SEALDD server may utilize the information provided by the application or VAL server to initiate the AF influence on URSP procedure with the 5G core network. The SEALDD server may include in the request one or more of an AF identifier, service parameters describing the application traffic (e.g. such as DNN, S-NSSAI, CE application descriptor, AF service identifier), target UF identifier(s) or information about the UE(s), UE location(s), UF capabilities, redundant transport information, temporal and spatial validity conditions, application or VAL server contact information such as FQDN or IP address and port number, subscription information for receiving notifications, etc. The SEALDD server may use the indication of using edge computing resources with the UE's location to discovery a list of DNAIs that could be used to support the application traffic. The UE may receive updated URSP rules in which the Traffic Descriptors and/or the Route Selection Descriptors (RSD) comprise information provided by the SEALDD server. A non-exhaustive list of examples comprises the IP descriptors comprising the application or VAL server IP address and port number, the Domain descriptor comprising the FQDN, and/or the RSD comprising the redundant transport information such as PDU Session Pair ID and RSN values to enable redundant PDU sessions for the UE. The PDU Session Pair ID and RSN values may have been provided to the SEALDD server by the 5G core network, the OAM system, or as part of pre-configuration. Alternatively, the SEALDD server may have been provisioned with mapping information correlating DNN and/or S-NSSAI with PDU Session Pair ID and RSN values.

If step 4 was triggered by step 2, the SEALDD server may inform the SEALDD client that redundant transport is enabled for the application on the UE. The SEALDD server may have received information about the UE from the VAL server or the network notification to be able to communicate with the SEALDD client. The notification may comprise one or more of the application identifier, the application or VAL server FQDN or IP address and port number, any temporal or spatial restrictions for the application traffic. The notification may comprise information regarding one or more URSPs that have been updated or newly configured onto the UE such that the SEALDD client is aware of them. The SEALDD client may acknowledge the notification from the SEALDD server and may comprise an update of the UE location and an indication of data segmentation requirement and packet size for the redundant transport. The SEALDD server acknowledges the application or VAL server with the result of the redundant transport request for the application.

In step 7, the SEALDD server may provide a status of the service request to the application or VAL server and may comprise a transaction and/or session identifier and a time stamp for the transaction.

In step 8, if step 3b triggered the application or VAL server to request for SEALDD service from the SEALDD server, the application or VAL, server may acknowledge the configuration request to the application or VAL client. The acknowledgement may indicate that SEALDD service have been configured for the application and comprise a list of one or more parameters for the application or VAL client to use when requesting service from the SEALDD client.

In step 9, the application or VAL client may make a service request for SEALDD service, possibly using the information provided by the application or VAL server.

In step 10, the SEALDD client may trigger the UE to establish redundant PDU sessions with the 5G core network. In this case, the SEALDD client may need to modify the existing PDU session established in step 2 to make it redundant, e.g. by providing the PDU Session Pair ID and the RSN, or the SEALDD client may need to manually manage the two PDU sessions without specifying the PDU sessions are redundant. The SEALDD client may also create two new PDU sessions for the redundant transport and delete the old PDU session if this has been communicated within the SEALDD layer.

In step 11, the SEALDD client may perform the appropriate data processing (e.g. data segmentation and duplication) of the data received from the application or VAL client and send the duplicated data over the redundant PDU sessions. The SEALDD server may receive the data from the redundant PDU sessions and perform the appropriate data re-assembly to send the data to the application or VAL server. Step 11 corresponds to step 9 as described above with respect to FIG. 3.

In the previous examples, either the application client or application server initiated the support of redundant transport for an application on a UE. For cases where the application traffic was initially established to use only a single transport and with SEALDD services, the SEALDD layer can support autonomously upgrading the application traffic for reliable communications based on information the SEALDD layer has about the UE and also on network performance. The SEALDD client may have access to one or more of performance measurements such as bit rate, round trip time latency, quantity of retransmissions, signal to noise ratio, signal strength, etc. received from lower layers of the UE. Using these performance measurements, the SEALDD client may detect when data transmission on a single transport can benefit from an upgrade to redundant transport. Similarly, a SEALDD server may have access to network performance measurements and analytics available from either the 5G network or OAM systems to make the same determination to upgrade a current application traffic from single transport to redundant transport.

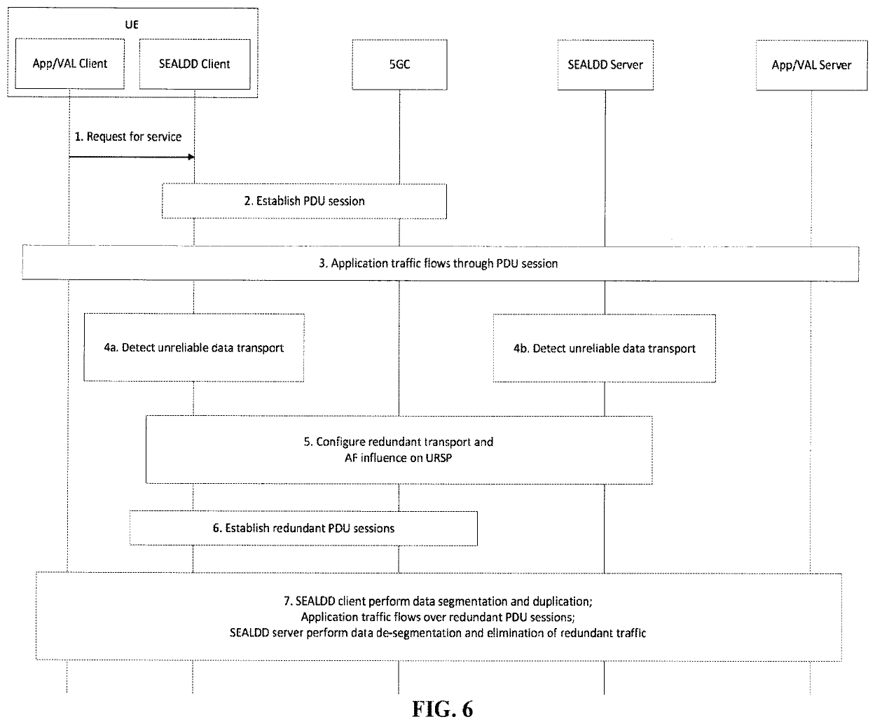

FIG. 6 shows an example where initially, an application or VAL client makes a request to send application traffic to an application or VAL server using SEALDD services. However, the request did not indicate the need for reliable communication and as a result, the SEALDD layer established a single transport for the application traffic. At least one of the SEALDD client or the SEALDD server may detect that the data transmission has degraded to the point where there are a threshold quantity of retransmissions. For example, the UE may be mobile and may have moved to an area where the signal strength is weak or where there is much congestion in the network. Detecting that data transmissions have degraded, the SEALDD client may make the determination to upgrade the single transport to dual transport for redundancy. If the SEALDD server had received network analytics on UE mobility and observed service experience that indicated the service experience for the UE has degraded from the initial service experience, the SEALDD server may also initiate the upgrade to redundant transport as shown in FIG. 6.

In step 1, an application client or VAL client on a UE may make a request to send data to an application or VAL server.

In step 2, in response, a SEALDD client may communicate with lower layers to create a PDU session for the UE in support of the application traffic.

In step 3, based on establishment of the PDU session, application data may be sent from the application or VAL client to the application or VAL server.

In step 4, the SEALDD client or SEALDD server may detect that the data transport has degraded and become unreliable or received predictions from analytics functions within the 5G system that the data transport will degrade and become unreliable. The SEALDD client may have obtained performance measurements from lower layers on the UE and the SEALDD server may have obtained performance measurements, QoS monitoring information, or network analytics from the 5G network or via the OAM system. The SEALDD client or server may decide to upgrade the PDU session to use redundant transport for the UE.

In step 5, the upgrade to use redundant transport may be communicated within the SEALDD layer between the SEALDD client and the SEALDD server. The SEALDD client may perform step 2 of FIG. 2 if the SEALDD client initiated the upgrade to redundant transport and the SEALDD server may perform step 4 of FIG. 3 if the SEALDD server initiated the upgrade to redundant transport. In addition, the SEALDD server may perform the AF influence on URSP procedure to update the UE with URSP rules to enable redundancy PDU sessions. Note that the AF influence on URSP procedure may need to be executed prior to the SEALDD server configuring redundant transport to the SEALDD client. For this case, the SEALDD client and SEALDD server may exchange information on how to upgrade to redundant transport from the existing transport. The information may indicate the creation of two new PDU sessions for the redundant transport and deleting the existing PDU session. The information may also specify the creation of a new PDU session and the modification of the existing PDU session or that the SEALDD layer would manage the new and existing PDU sessions manually.

In step 6, the SEALDD client may trigger the UE to establish redundant PDU sessions with the 5G core network. In this case, the SEALDD client may need to modify the existing PDU session established in step 2 to make it redundant, e.g. by providing the PDU Session Pair ID and the RSN, or the SEALDD client may need to manually manage the two PDU sessions without specifying the PDU sessions are redundant. The SEALDD client may also create two new PDU sessions for the redundant transport and delete the old PDU session if this has been communicated within the SEALDD layer.

In step 7, the SEALDD client may perform the appropriate data processing (e.g. data segmentation and duplication) of the data received from the application or VAL client and send the duplicated data over the redundant PDU sessions. The SEALDD server may receive the data from the redundant PDU sessions and perform the appropriate data re-assembly to send the data to the application or VAL server. Step 7 corresponds to step 9 as described above with respect to FIG. 3.

SEALDD Layer Interface with Lower Layers for Redundant Transport

Upon receiving a request for SEALDD service, the SEALDD layer may interact with the 5G network to enable the service for the application traffic. The SEALDD server may access the 5G core network by utilizing one or more of the monitoring, provisioning, and analytics reporting capabilities of the Network Exposure Function (NEF). The SEALDD server may also have access to OAM systems to further obtain configuration or network information to provide better data delivery services. Similarly, the SEALDD client on a UF may communicate with lower layers of the protocol stack to establish and manage PDU sessions for the application traffic and also to obtain information about the UE to better manage data delivery services for applications on the UE.

When a SEALDD client receives an initial request for service from application clients, the SEALDD client may communicate with lower layers of the UE to establish PDU sessions for the UE. In the communication, the SEALDD client may include information for the application traffic, such as one or more of the application identifier, application server contact information (e.g. FQDN, IP address and port number), and QoS requirements. If the SEALDD client had determined that redundant transport is required, the communication may also comprise the PDU Session Pair ID and/or the RSN to indicate the PDU session should enable the redundant feature. The SEALDD client may have received the PDU Session Pair ID and/or the RSN from the SEALDD server during the establishment of the redundant transport within the SEALDD layer.

A SEALDD server may have access to information about network performance and/or UE configuration through the NEF interface with the 5G network or via an interface to OAM systems. Using the information, the SEALDD server may evaluate network performance statistics and/or predictions to assist in making the determination for upgrading application traffic to using redundant transport. As an example, the SEALDD server may have subscribed to receiving statistics and predictions from the NWDAF on network function loading, network performance, observed service experience, UE mobility and communication, etc. In addition, the SEALDD server may have obtained UE capabilities and other UE information from the SEALDD client to assist with making the determination.

Once the SEALDD server has made the determination for redundant transport, it may communicate to the 5G network, e.g. via the NEF interface, to influence application traffic through the update of URSP rules to the UE. The SEALDD server may be able to derive the PDU Session Pair ID and/or RSN values from mapping information provided by the 5G network or OAM systems based on DNN and S-NSSAI information used for the PDU session. The PDU Session Pair ID and/or RSN may be provided in the URSP rule update or to the SEALDD client for use in requesting the establishment of PDU sessions to support the redundant transport.

### Graphical User Interface

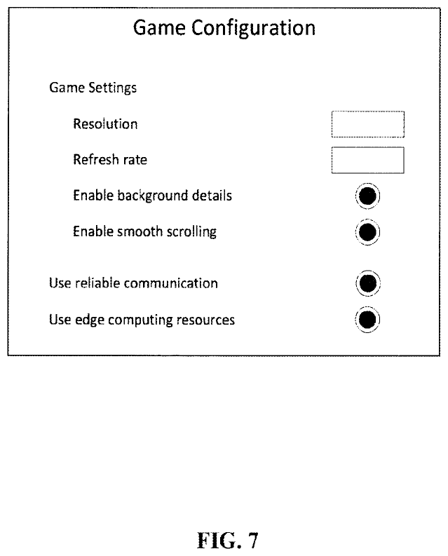

A graphical user interface such as the example shown in FIG. 7 may be presented to a user of a gaming application on a UE. The GUI allows the user to configure the settings for the game, such as the resolution, refresh rate, background details and smooth scrolling. The game settings may be used by an application or VAL client/server to derive QoS requirements that could be passed to the SEALDD client/server when requesting service. In addition, the GUI may offer other settings that may impact game performance and be used to trigger SEAL data delivery services: settings for reliable communication and usage of edge computing resources.

The 3rd Generation Partnership Project (3GPP) develops technical standards for cellular telecommunications network technologies, including radio access, the core transport network, and service capabilities-including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G.” 3GPP NR standards development is expected to continue and include the definition of next generation radio access technology (new RAT), which is expected to include the provision of new flexible radio access below 7 GHZ, and the provision of new ultra-mobile broadband radio access above 7 GHz. The flexible radio access is expected to consist of a new, non-backwards compatible radio access in new spectrum below 7 GHZ, and it is expected to include different operating modes that may be multiplexed together in the same spectrum to address a broad set of 3GPP NR use cases with diverging requirements. The ultra-mobile broadband is expected to include cmWave and mm Wave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive recall, disaster alerts, real-time gaming, multi-person video calls, autonomous driving, augmented reality, tactile internet, virtual reality, home automation, robotics, and aerial drones to name a few. All of these use cases and others are contemplated herein.

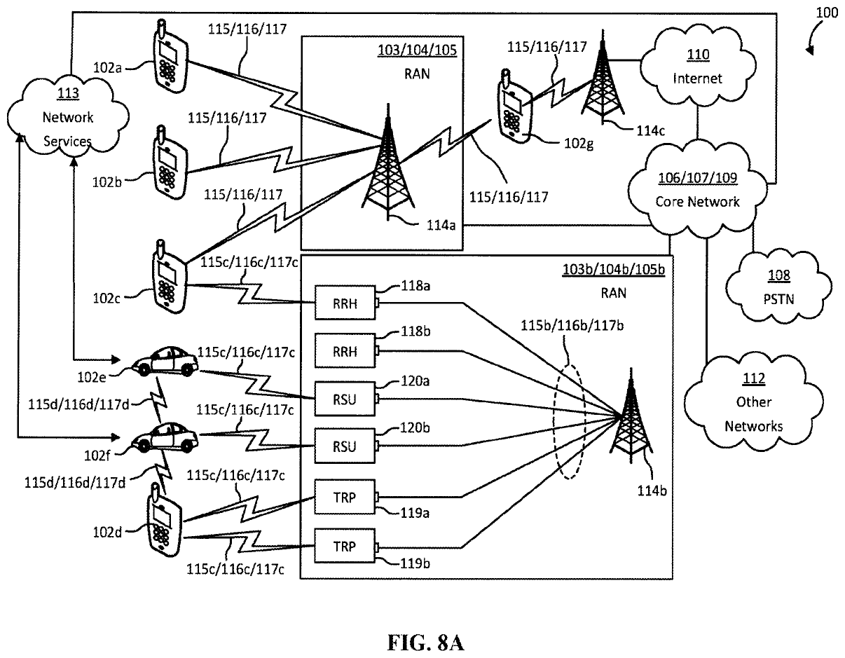

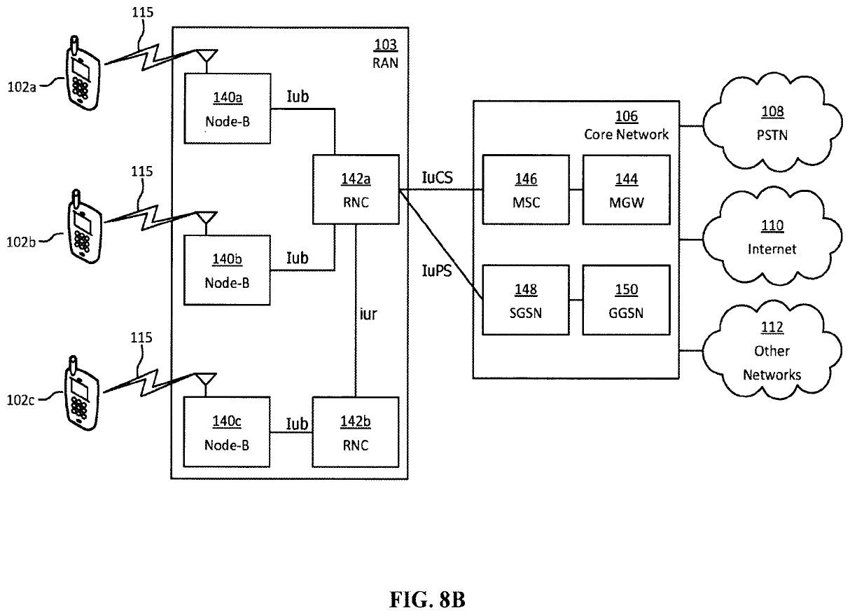

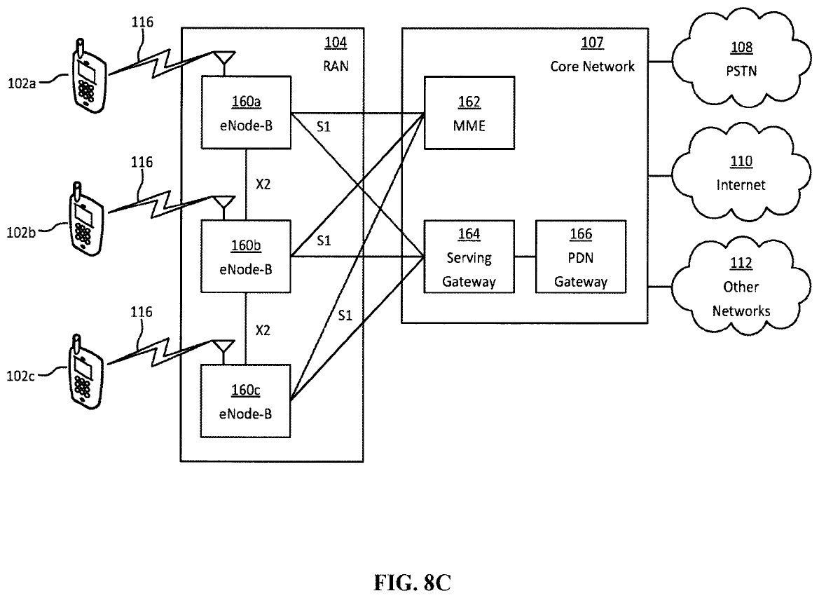

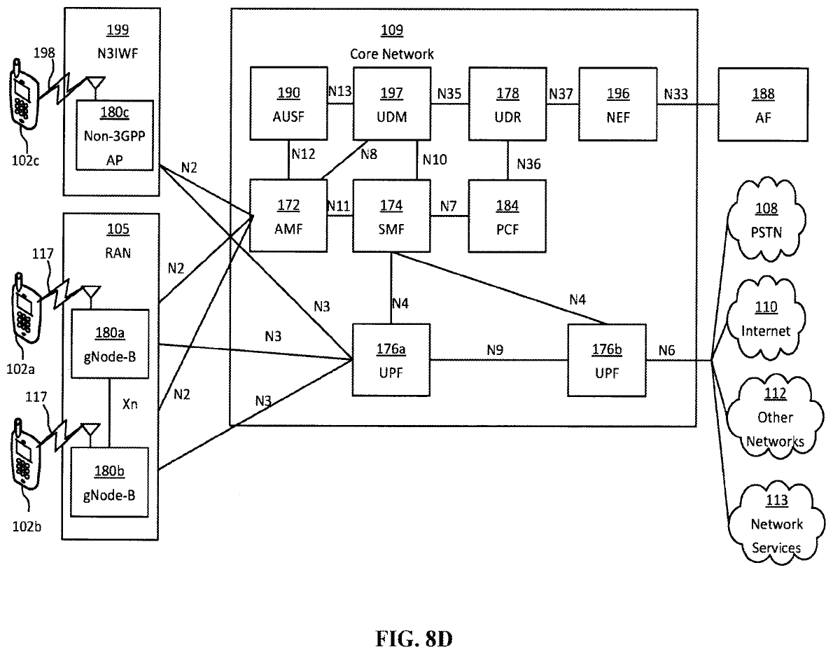

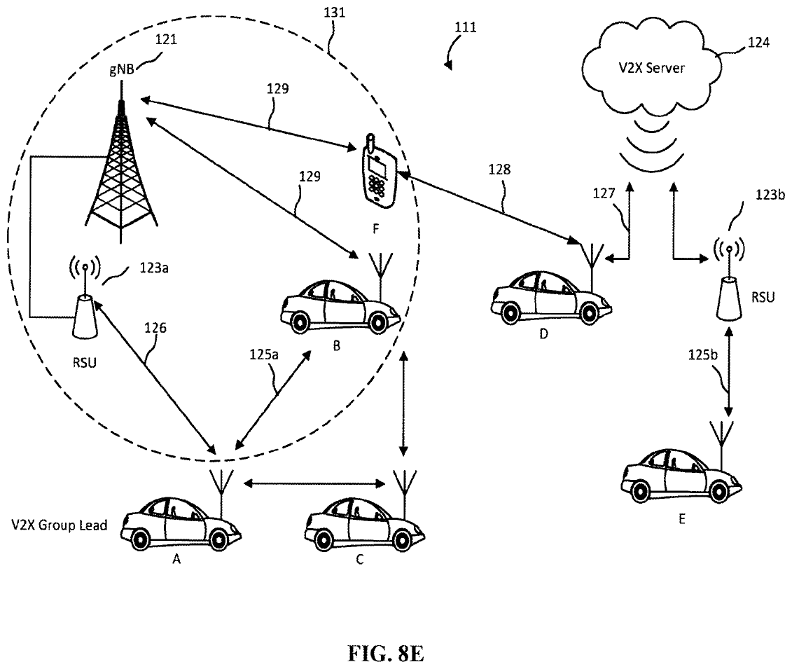

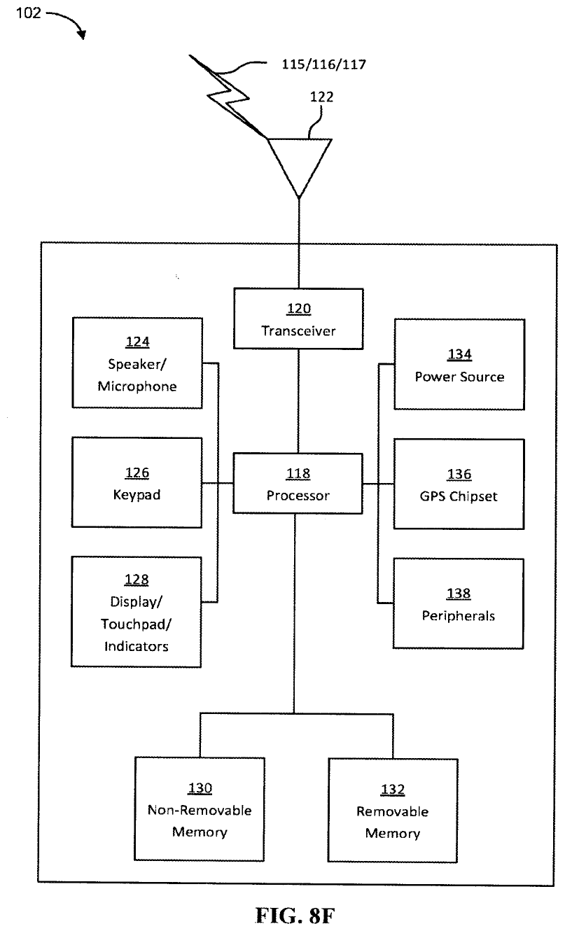

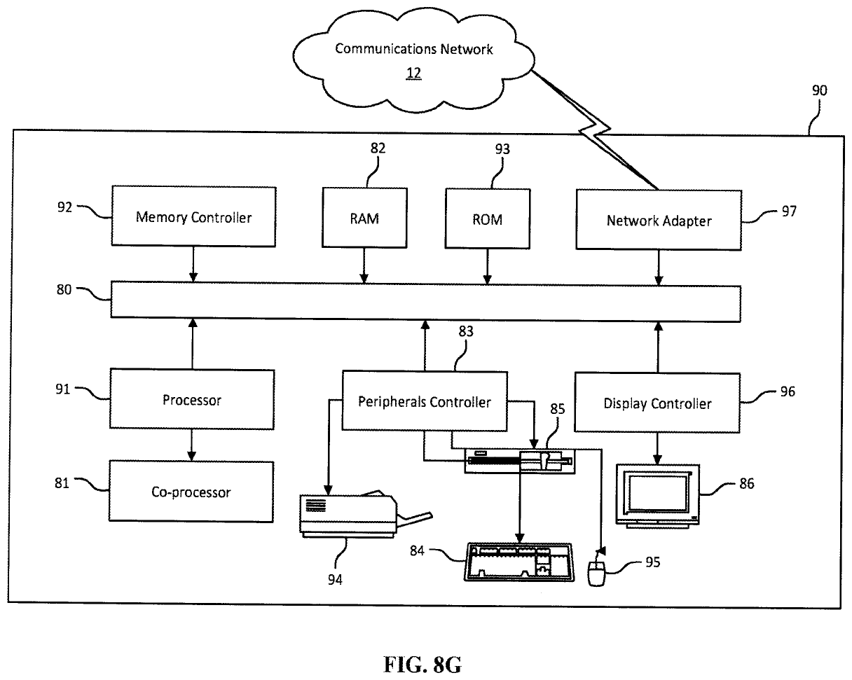

FIG. 8A illustrates an example communications system 100 in which the systems, methods, and apparatuses described and claimed herein may be used. The communications system 100 may include wireless transmit/receive units (WTRUs) 102a, 102b, 102c, 102d, 102e, 102f, and/or 102g, which generally or collectively may be referred to as WTRU 102 or WTRUs 102. The communications system 100 may include, a radio access network (RAN) 103/104/105/103b/104b/105b, a core network 106/107/109, a public switched telephone network (PSTN) 108, the Internet 110, other networks 112, and Network Services 113. 113. Network Services 113 may include, for example, a V2X server, V2X functions, a ProSe server, ProSe functions, IoT services, video streaming, and/or edge computing, etc.

It will be appreciated that the concepts disclosed herein may be used with any quantity of WTRUs, base stations, networks, and/or network elements. Each of the WTRUs 102 may be any type of apparatus or device configured to operate and/or communicate in a wireless environment. In the example of FIG. 8A, each of the WTRUs 102 is depicted in FIGS. 8A-E as a hand-held wireless communications apparatus. It is understood that with the wide variety of use cases contemplated for wireless communications, each WTRU may comprise or be included in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus or truck, a train, or an airplane, and the like.

The communications system 100 may also include a base station 114a and a base station 114b. In the example of FIG. 8A, each base stations 114a and 114b is depicted as a single element. In practice, the base stations 114a and 114b may include any number of interconnected base stations and/or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, and/or the other networks 112. Similarly, base station 114b may be any type of device configured to wiredly and/or wirelessly interface with at least one of the Remote Radio Heads (RRHs) 118a, 118b, Transmission and Reception Points (TRPs) 119a, 119b, and/or Roadside Units (RSUs) 120a and 120b to facilitate access to one or more communication networks, such as the core network 106/107/109, the Internet 110, other networks 112, and/or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, and/or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, and/or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, and/or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations and/or network elements (not shown), such as a Base Station Controller (BSC), a Radio Network Controller (RNC), relay nodes, etc. Similarly, the base station 114b may be part of the RAN 103b/104b/105b, which may also include other base stations and/or network elements (not shown), such as a BSC, a RNC, relay nodes, etc. The base station 114a may be configured to transmit and/or receive wireless signals within a particular geographic region, which may be referred to as a cell (not shown). Similarly, the base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, for example, the base station 114a may include three transceivers, e.g., one for each sector of the cell. The base station 114a may employ Multiple-Input Multiple Output (MIMO) technology and, therefore, may utilize multiple transceivers for each sector of the cell, for example.

The base station 114a may communicate with one or more of the WTRUs 102a, 102b, 102c, and 102g over an air interface 115/116/117, which may be any suitable wireless communication link (e.g., Radio Frequency (RF), microwave, infrared (IR), ultraviolet (UV), visible light, cmWave, mmWave, etc.). The air interface 115/116/117 may be established using any suitable Radio Access Technology (RAT).

The base station 114b may communicate with one or more of the RRHs 118a and 118b, TRPs 119a and 119b, and/or RSUs 120a and 120b, over a wired or air interface 115b/116b/117b, which may be any suitable wired (e.g., cable, optical fiber, etc.) or wireless communication link (e.g., RF, microwave, IR, UV, visible light, cmWave, mmWave, etc.). The air interface 115b/116b/117b may be established using any suitable RAT.

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., RF, microwave, IR, ultraviolet UV, visible light, cmWave, mmWave, etc.) The air interface 115c/116c/117c may be established using any suitable RAT.

The WTRUs 102 may communicate with one another over a direct air interface 115d/116d/117d, such as Sidelink communication which may be any suitable wireless communication link (e.g., RF, microwave, IR, ultraviolet UV, visible light, cmWave, mmWave, etc.) The air interface 115d/116d/117d may be established using any suitable RAT.

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and/or RSUs 120a and 120b in the RAN 103b/104b/105b and the WTRUs 102c, 102d, 102e, and 102f, may implement a radio technology such as Universal Mobile Telecommunications System (UMTS) Terrestrial Radio Access (UTRA), which may establish the air interface 115/116/117 and/or 115c/116c/117c respectively using Wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

The base station 114a in the RAN 103/104/105 and the WTRUs 102a, 102b, 102c, and 102g, or RRHs 118a and 118b, TRPs 119a and 119b, and/or RSUs 120a and 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A), for example. The air interface 115/116/117 or 115c/116c/117c may implement 3GPP NR technology. The LTE and LTE-A technology may include LTE D2D and/or V2X technologies and interfaces (such as Sidelink communications, etc.) Similarly, the 3GPP NR technology may include NR V2X technologies and interfaces (such as Sidelink communications, etc.).

The base station 114a in the RAN 103/104/105 and the WTRUs 102a, 102b, 102c, and 102g or RRHs 118a and 118b, TRPs 119a and 119b, and/or RSUs 120a and 120b in the RAN 103b/104b/105b and the WTRUs 102c, 102d, 102e, and 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 8A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like. The base station 114c and the WTRUs 102, e.g., WTRU 102e, may implement a radio technology such as IEEE 802.11 to establish a Wireless Local Area Network (WLAN). Similarly, the base station 114c and the WTRUs 102, e.g., WTRU 102d, may implement a radio technology such as IEEE 802.15 to establish a wireless personal area network (WPAN). The base station 114c and the WTRUs 102, e.g., WRTU 102e, may utilize a cellular-based RAT (e.g., WCDMA, CDMA2000, GSM, LTE, LTE-A, NR, etc.) to establish a picocell or femtocell. As shown in FIG. 8A, the base station 114c may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, messaging, authorization and authentication, applications, and/or Voice Over Internet Protocol (VOIP) services to one or more of the WTRUs 102. For example, the core network 106/107/109 may provide call control, billing services, mobile location-based services, pre-paid calling, Internet connectivity, packet data network connectivity, Ethernet connectivity, video distribution, etc., and/or perform high-level security functions, such as user authentication.

Although not shown in FIG. 8A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102 to access the PSTN 108, the Internet 110, and/or other networks 112. The PSTN 108 may include circuit-switched telephone networks that provide Plain Old Telephone Service (POTS). The Internet 110 may include a global system of interconnected computer networks and devices that use common communication protocols, such as the Transmission Control Protocol (TCP), User Datagram Protocol (UDP), and the internet protocol (IP) in the TCP/IP internet protocol suite. The other networks 112 may include wired or wireless communications networks owned and/or operated by other service providers. For example, the networks 112 may include any type of packet data network (e.g., an IEEE 802.3 Ethernet network) or another core network connected to one or more RANs, which may employ the same RAT as the RAN 103/104/105 and/or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links. For example, the WTRU 102g shown in FIG. 8A may be configured to communicate with the base station 114a, which may employ a cellular-based radio technology, and with the base station 114c, which may employ an IEEE 802 radio technology.

Although not shown in FIG. 8A, it will be appreciated that a User Equipment may make a wired connection to a gateway. The gateway maybe a Residential Gateway (RG). The RG may provide connectivity to a Core Network 106/107/109. It will be appreciated that many of the ideas contained herein may equally apply to UEs that are WTRUs and UEs that use a wired connection to connect to a network. For example, the ideas that apply to the wireless interfaces 115, 116, 117 and 115c/116c/117c may equally apply to a wired connection.

FIG. 8B is a system diagram of an example RAN 103 and core network 106. As noted above, the RAN 103 may employ a UTRA radio technology to communicate with the WTRUs 102a, 102b, and 102c over the air interface 115. The RAN 103 may also be in communication with the core network 106. As shown in FIG. 8B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs).

As shown in FIG. 8B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 8B may include a media gateway (MGW) 144, a Mobile Switching Center (MSC) 146, a Serving GPRS Support Node (SGSN) 148, and/or a Gateway GPRS Support Node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned and/or operated by other service providers.

FIG. 8C is a system diagram of an example RAN 104 and core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 8C, the eNode-Bs 160a, 160b, and 160c may communicate with one another over an X2 interface.

The core network 107 shown in FIG. 8C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the SI interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned and/or operated by other service providers.

FIG. 8D is a system diagram of an example RAN 105 and core network 109. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and g Node-Bs, which may be the core network 109 via one or multiple gNBs. The gNode-Bs 180a and 180b may implement MIMO, MU-MIMO, and/or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink and/or downlink, and the like. As shown in FIG. 8D, the g Node-Bs 180a and 180b may communicate with one another over an Xn interface, for example.

The core network 109 shown in FIG. 8D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as system 90 illustrated in FIG. 8G.

In the example of FIG. 8D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned and/or operated by an entity other than the core network operator. It will also be appreciated that a 5G core network may not consist of all of these elements, may consist of additional elements, and may consist of multiple instances of each of these elements. FIG. 8D shows that network functions directly connect to one another, however, it should be appreciated that they may communicate via routing agents such as a diameter routing agent or message buses.

In the example of FIG. 8D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 8D.

The SMF 174 may be connected to the AMF 172 via an N11 interface. Similarly, the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 8D. The PCF 184 may provide policy rules to control plane nodes such as the AMF 172 and SMF 174, allowing the control plane nodes to enforce these rules. The PCF 184 may send policies to the AMF 172 for the WTRUs 102a, 102b, and 102c so that the AMF may deliver the policies to the WTRUs 102a, 102b, and 102c via an N1 interface. Policies may be enforced, or applied, at the WTRUs 102a, 102b, and 102c.

The UDR 178 may act as a repository for authentication credentials and subscription information. The UDR may connect to network functions, so that network function may add to, read from, and modify the data that is in the repository. For example, the UDR 178 may connect to the PCF 184 via an N36 interface. Similarly, the UDR 178 may connect to the NEF 196 via an N37 interface, and the UDR 178 may connect to the UDM 197 via an N35 interface.

The UDM 197 may serve as an interface between the UDR 178 and other network functions. The UDM 197 may authorize network functions to access of the UDR 178. For example, the UDM 197 may connect to the AMF 172 via an N8 interface, the UDM 197 may connect to the SMF 174 via an N10 interface. Similarly, the UDM 197 may connect to the AUSF 190 via an N13 interface. The UDR 178 and UDM 197 may be tightly integrated.

The AUSF 190 performs authentication related operations and connects to the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect to an AF 188 via an N33 interface, and it may connect to other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance, and isolation.

3GPP has designed the 5G core network to support Network Slicing. Network Slicing is a useful tool that network operators may use to support the diverse set of 5G use cases (e.g., massive IoT, critical communications, V2X, and enhanced mobile broadband) which demand diverse and sometimes extreme requirements. Without the use of network slicing techniques, it is likely that the network architecture would not be flexible and scalable enough to efficiently support a wider range of use cases needed when each use case has its own specific set of performance, scalability, and availability requirements. Furthermore, introduction of new network services should be made more efficient.

Referring again to FIG. 8D, in a network slicing scenario, a WTRU 102a, 102b, or 102c may connect to an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, which serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned and/or operated by other service providers.

The core network entities described herein and illustrated in FIG. 8A, FIG. 8C, FIG. 8D, and FIG. 8E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 8A-E are provided by way of example only, and it is understood that the subject matter disclosed and claimed herein may be embodied or implemented in any similar communication system, whether presently defined or defined in the future.

FIG. 8E illustrates an example communications system 111 in which the systems, methods, apparatuses described herein may be used. Communications system 111 may include Wireless Transmit/Receive Units (WTRUs) A, B, C, D, E, F, a base station gNB 121, a V2X server 124, and Roadside Units (RSUs) 123a and 123b. In practice, the concepts presented herein may be applied to any quantity of WTRUs, base station gNBs, V2X networks, and/or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 8E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For example, in the example of FIG. 8E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 8F is a block diagram of an example apparatus or device WTRU 102 that may be configured for wireless communications and operations in accordance with the systems, methods, and apparatuses described herein, such as a WTRU 102 of FIGS. 8A-E. As shown in FIG. 8F, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 8F and described herein.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 8F depicts the processor 118 and the transceiver 120 as separate components, it will be appreciated that the processor 118 and the transceiver 120 may be integrated together in an electronic package or chip.

The transmit/receive element 122 of a UE may be configured to transmit signals to, or receive signals from, a base station (e.g., the base station 114a of FIG. 8A) over the air interface 115/116/117 or another UE over the air interface 115d/116d/117d. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. It will be appreciated that the transmit/receive element 122 may be configured to transmit and/or receive any combination of wireless or wired signals.

In addition, although the transmit/receive element 122 is depicted in FIG. 8F as a single element, the WTRU 102 may include any quantity of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit. The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 118 may access information from, and store data in, memory that is not physically located on the WTRU 102, such as on a server that is hosted in the cloud or in an edge computing platform or in a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method

The processor 118 may further be coupled to other peripherals 138, which may include one or more software and/or hardware modules that provide additional features, functionality, and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect to other components, modules, or systems of such apparatuses or devices via one or more interconnect interfaces, such as an interconnect interface that may comprise one of the peripherals 138.

FIG. 8G is a block diagram of an exemplary computing system 90 in which one or more apparatuses of the communications networks illustrated in FIG. 8A, FIG. 8C, FIG. 8D and FIG. 8E may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIGS. 8A-E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods, and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations, or functions described herein may be implemented in the form of such computer executable instructions, executing on the processor of an apparatus or computing system configured for wireless and/or wired network communications. Computer readable storage media includes volatile and nonvolatile, removable, and non-removable media implemented in any non-transitory (e.g., tangible, or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information, and which may be accessed by a computing system.

The invention claimed is:

1. A method comprising:
establishing, by a redundant transport client of a user device and based on receiving a request for service from an application client executing on the user device, a protocol data unit (PDU) session;
sending, from the user device and via the PDU session, application data to an application server associated with the application;
determining, by at least one of the redundant transport client or a redundant transport server, based on monitoring one or more performance metrics associated with the PDU session, to configure redundant transport for the application;
sending, by the redundant transport client and to the redundant transport server, a request for the redundant transport server to configure redundant transport for the application;
receiving, based at least in part on the request for the redundant transport server to configure redundant transport for the application, one or more user equipment (UE) route selection policy (URSP) rules for establishing redundant PDU sessions;
receiving, from the redundant transport server, an indication of a redundant transport session associated with the application; and
establishing, based at least in part on the one or more URSP rules, by the redundant transport client and for the user device, a plurality of redundant PDU sessions associated with the user device.

2. The method of claim 1, further comprising receiving, from the application, a request to send, via redundant transport, the application data to the application server.

3. The method of claim 1, further comprising:
duplicating the application data on at least two of the plurality of redundant PDU sessions; and
sending, via the at least two of the plurality of redundant PDU sessions, the duplicated application data to the redundant transport server.

4. The method of claim 2, wherein the request comprises at least one of an application identifier, an indication of the application server, a quality of service indication associated with the application data, mobility information associated with the user device, a request for reliable communication, or a restriction associated with the application data.

5. The method of claim 1, wherein the URSP rules comprise at least one of a vertical application layer (VAL) server internet protocol (IP) address and port number, a fully qualified domain name (FQDN), or a PDU session pair identifier and redundancy sequence number (RSN).

6. The method of claim 1, wherein the redundant transport client is further configured to segment the application data based on at least one of a transmission quality, a size associated with the application data, or a maximum packet size of application data associated with at least one of the redundant PDU sessions.

7. The method of claim 1, wherein the redundant PDU sessions comprise disjointed user plane paths.

8. The method of claim 2, wherein the redundant transport server is configured to send one instance of the duplicated application data to the application.

9. The method of claim 7, wherein the redundant transport server is configured to, based on receiving a plurality of instances of the application data from the redundant PDU sessions, de-duplicate the plurality of instances of the application data.

10. A server device comprising:
one or more processors; and
memory storing instructions that, when executed by the one or more process, cause the server device to:
determine, based on at least one of monitoring one or more performance metrics associated with at least one of a protocol data unit (PDU) session or receiving one or more network analytics from a 5G core network, to configure redundant transport for an application executing on a user device;
receive, from a redundant transport client, a request to configure redundant transport associated with the application;
send, based on the receiving the request to configure redundant transport associated with the application and to the 5G core network, an application function (AF) influence on a user equipment (UE) route selection policy (URSP) request;
send, to the redundant transport client, an indication of implementation of a redundant transport session; and
receive, from the redundant transport client, at least one copy of application data associated with the application, the at least one copy of application data received via one PDU session of a plurality of redundant PDU sessions.

11. The server device of claim 10, wherein the redundant transport client and the application are associated with a user device.

12. The server device of claim 10, wherein the AF influence comprises one or more of a UE application descriptor, an AF service identifier, an indication associated with the UE, an indication of an application server, or a redundant transport indicator.

13. The server device of claim 10, wherein the at least one copy of application data is segmented application data, and wherein the server device is configured to send, to an application server associated with the application, the segmented application data.

14. The server device of claim 10, wherein the plurality of redundant PDU sessions comprise disjointed user plane paths.

15. The server device of claim 10, wherein the instructions, when executed, further cause the server device to:
receive a plurality of copies of the application data, wherein each copy of the application data is received from one of the plurality of redundant PDU sessions; and
de-duplicate the plurality of copies of the application data.

16. The method of claim 1, wherein the one or more performance metrics comprises at least one of a bit rate of the PDU session, a round trip time latency of the PDU session, a quantity of retransmissions associated with the PDU session, a signal to noise ratio of the PDU session, or a signal strength associated with the PDU session.

17. The server device of claim 10, wherein the instructions further cause the server device to send, in response to receiving the at least one copy of the application data, the at least one copy of the application data to an application server associated with the application.

18. The server device of claim 10, wherein the one or more performance metrics associated with the PDU session comprise at least one of a bit rate of the PDU session, a round trip time latency of the PDU session, a quantity of retransmissions associated with the PDU session, a signal to noise ratio of the PDU session, or a signal strength associated with the PDU session.
